(19) United States
(12) Patent Application Publication
(10) Pub. No.: US 2008/0267181 A1
(43) Pub. Date: Oct. 30, 2008

(54) Selective Multicasting of Sensor Data for Reliable Delivery

(75) Inventors: Indermohan Monga, Acton, MA (US); Garth Jenkins, Belmont, MA (US); Harish Sankaran, Billerica, MA (US)

Correspondence Address: GUERIN & RODRIGUEZ, LLP, 5 MOUNT ROYAL AVENUE, MOUNT ROYAL OFFICE PARK, MARLBOROUGH, MA, 01752, US

(73) Assignee: NORTEL NETWORKS LIMITED, ST. LAURENT, QC (CA)

(21) Appl. No.: 12/096,229

(22) PCT Filed: Nov. 6, 2006
(86) PCT No.: PCT/US06/60562

§ 371 Date: Jun. 5, 2008

Related U.S. Application Data
(60) Provisional application No. 60/734,479, filed on Nov. 8, 2005.

(51) Int. Cl. H04L 12/56

(52) U.S. Cl. 370/390

(57) ABSTRACT

Described is a method for reliable transmission of sensor data and sensor commands. The method is particularly useful for shared packet networks and lossy wireless networks where the rate of packet drops can be significant. A network access node receives a data packet that includes the sensor data and multicasts the data packet towards an aggregation node. Each data packet preferably is transmitted over a unique network path. The number of multicast data packets is determined according to one or more network parameters such as network congestion, packet drop probability, the priority and class of service of the data packet, and the number of unique network paths between the network access node and an aggregation node. The first data packet to arrive at the aggregation node is forwarded to the application node and subsequently received data packets with identical sensor data are discarded.

### RELATED APPLICATION

This application claims the benefit of the earlier filing date of U.S. Provisional Patent Application Ser. No. 60/734,479, filed Nov. 8, 2005, titled “Selective Sensor Multicast for Guaranteed Delivery,” the entirety of which is incorporated herein by reference.

### FIELD OF THE INVENTION

The invention relates generally to the transmission of sensor data over packet-based networks. More particularly, the invention relates to a method for selectively generating multiple copies of data packets in a network over a section deemed lossy to ensure packet delivery.

### BACKGROUND OF THE INVENTION

Advancements in computing technology have led to the production of sensors capable of observing and reporting various real-world phenomena in a time-sensitive manner. Additionally, the growth in distributed communication technology (e.g., the Internet) has led to the development of sensor networks. Sensor networks are used in numerous applications, including military, industrial and civilian applications. Generally, sensors are adapted to detect or monitor certain events or conditions. A sensor may be simple, such as a device that monitors temperature, or more complex, such as a video camera. Data generated at the sensor are transmitted in data packets over a sensor network to one or more application nodes. An application node can include an application software instantiation that can process the sensor data in any one of a variety of ways or the application node can be a user interface that presents the sensor data in numerical or graphical form to a user.

Sensors have been used for critical industrial applications in the past. More recently, sensors have been used for homeland security and public safety applications. Sensors are transitioning from “wired-based” or “circuit-based” implementations to packet-based networks over shared infrastructure and wireless communication networks.

In many instances, sensors generate critical data which needs to be quickly and reliably transmitted to users and applications to enable rapid detection and reaction to a particular event. Shared packet networks have end-to-end quality of service issues and can exhibit “packet drops.” For time critical applications, existing techniques such as Transmission Control Protocol (TCP) with packet retransmission may result in an unacceptable delay for the retransmitted packets. In addition, sensors generally do not have sufficiently large buffers and windowing algorithms to ensure end-to-end delivery of sensor data. Moreover, it is not practical for large-scale applications to maintain windowing and acknowledgement procedures for large numbers (e.g., thousands) of sensors.

What is needed is a method for reliably transmitting time-critical sensor data to an application that avoids the above-described problems. The present invention satisfies this need and provides additional advantages.

### SUMMARY OF THE INVENTION

In one aspect, the invention features a method for selectively multicasting sensor data. Sensor data are received at a network access node. A number of data packets are transmitted towards an aggregation node. Each data packet has a payload that includes the sensor data. The number of data packets is determined in response to at least one network parameter. A first one of the data packets received at the aggregation node is forwarded to at least one application node. Any of the data packets received at the aggregation node after the first one of the data packets are deleted.

In another aspect, the invention features a method for selectively multicasting command data to a sensor. A number of data packets are transmitted towards a network access node. Each data packet has a payload including at least one sensor command. The number of data packets is determined in response to at least one network parameter. A first one of the data packets received at the network access node is forwarded to at least one sensor. Any of the data packets received at the network access node after the first one of the data packets are deleted.

In still another aspect, the invention features a network for reliable transmission of sensor data. The network includes a network access node configured to receive sensor data from at least one sensor. The network access node also generates and transmits a number of data packets. Each data packet includes the sensor data and a common identifier. The network also includes an aggregation node in communication with the network access node through a plurality of network paths. The aggregation node is adapted to receive the transmitted data packets and to delete all but a first received one of the data packets.

In yet another aspect, the invention features a method for selectively multicasting sensor data for reliable transmission. Sensor data are received at a network access node. A number of data packets are transmitted towards an aggregation node. Each data packet has a payload that includes the sensor data. The number of data packets is determined in response to at least one network parameter. An error-corrected data packet is generated from a first one of the data packets and a later-received one of the data packets at the aggregation node and forwarded to at least one application node.

### BRIEF DESCRIPTION OF THE DRAWINGS

The above and further advantages of this invention may be better understood by referring to the following description in conjunction with the accompanying drawings, in which like numerals indicate like structural elements and features in the various figures. For clarity, not every element may be labeled in every figure. The drawings are not necessarily to scale, emphasis instead being placed upon illustrating the principles of the invention.

FIG. 1 illustrates a network environment in which the method of the invention can be practiced.

FIG. 2 is a flowchart representation of an embodiment of a method for selectively multicasting sensor data for reliable transmission according to the invention.

FIG. 3 is a graphical representation of an example of sensor data packets arriving over time at an aggregation node.

FIG. 4 is a flowchart representation of an embodiment of a method to selectively multicast command data for reliable transmission to a sensor according to the invention.

### DETAILED DESCRIPTION

In brief overview, the invention relates to a method and a network for reliable transmission of sensor data from sensors to application nodes. The method is particularly useful for shared packet networks and lossy wireless networks where the rate of data packet “drops” can be significant due to RF interference and environmental conditions. The method may be implemented only for the section of a network deemed unreliable or lossy. A network access node at the edge of the network receives a data packet that includes the sensor data. The data packet is multicast such that multiple data packets carrying the same sensor data are transmitted to an aggregation node, where the network access node and the aggregation node span the unreliable section of the network. Each data packet preferably is transmitted over a unique network path. The number of multicast data packets is determined according to one or more network parameters such as network congestion, packet drop probability, the priority and class of service of the data packet, and the number of unique network paths between the network access node and an aggregation node which is typically “adjacent” to the application node. The first data packet to arrive at the aggregation node is forwarded to the application node. Data packets subsequently received at the aggregation node that contain the same sensor data are deleted. Because sensor data packets are small in comparison to many other types of data packets, the impact on the network is typically insignificant. For instance, some of the sensor packets might be status packets that do not need timely delivery, in which case, even across a lossy link, the status packets may not be multicast to reduce the probability of congestion in the network. In some embodiments, the multicast edge nodes are also configured to raise alarms if certain sensor packets exceed their latency or loss bounds allocated to their portion of the network.

The multicasting technique is transparent to sensor and application nodes on the network. Intelligent network access nodes 14 and aggregation nodes 18 manage the multicasting independent of other nodes and devices in the network. The method results in near-guaranteed delivery of sensor data to the applications. Moreover, the first received data packet is likely to satisfy timeliness requirements. These benefits over conventional sensor network data transmission schemes can be of significant importance in critical sensor applications. For comparison, delivery through the network using Transmission Control Protocol (TCP) includes acknowledging successful receipt of the sensor data packet. If a data packet is not received at the aggregation node, the network access node waits for the expiration of a timeout interval before retransmitting the data packet. This delay can be intolerable for time-critical sensor applications.

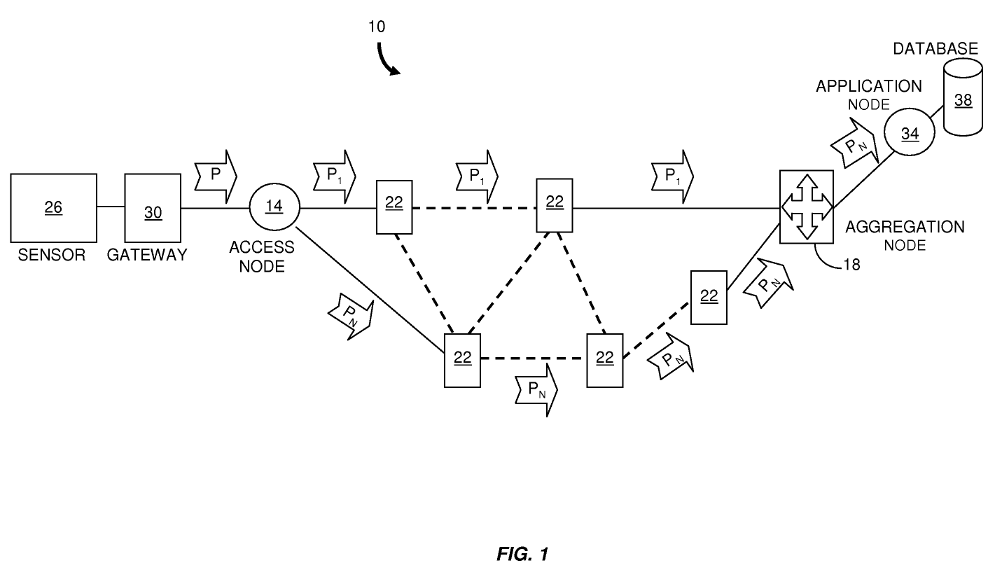

FIG. 1 illustrates a network environment 10 in which the method of the invention can be practiced. The network environment 10 can include, for example, a shared packet network or a wireless network in which a network access node 14 (or edge node) can communicate with an aggregation node 18 through a number of network paths illustrated as lines between network routers 22. The dashed lines illustrate where wireless paths may exist. As used herein, an aggregation node 18 means a network node at which multiple data packets having identical payloads are received; however, these data packets are not aggregated or combined in the conventional sense, but are instead discarded or deleted at the aggregation node if received after the first data packet. A single sensor 26 interfaces with the network access node 14 through a sensor gateway 30. In one embodiment, the sensor gateway 30 is an XML soft gateway and the aggregation node 18 is an XML soft switch. An application node 34 communicates with the aggregation node 18 and an associated database 38. Although only a single sensor 26 and application node 34 are shown, the invention contemplates any number of sensors 26 and application nodes 34 communicating with the network access node 14 and aggregation node 18, respectively. Generally the aggregation nodes 18 are located where data packets exit the lossy networks. In another embodiment, the network configuration 10 includes multiple aggregation nodes 18 to receive sensor data packets transmitted through multiple intervening lossy networks.

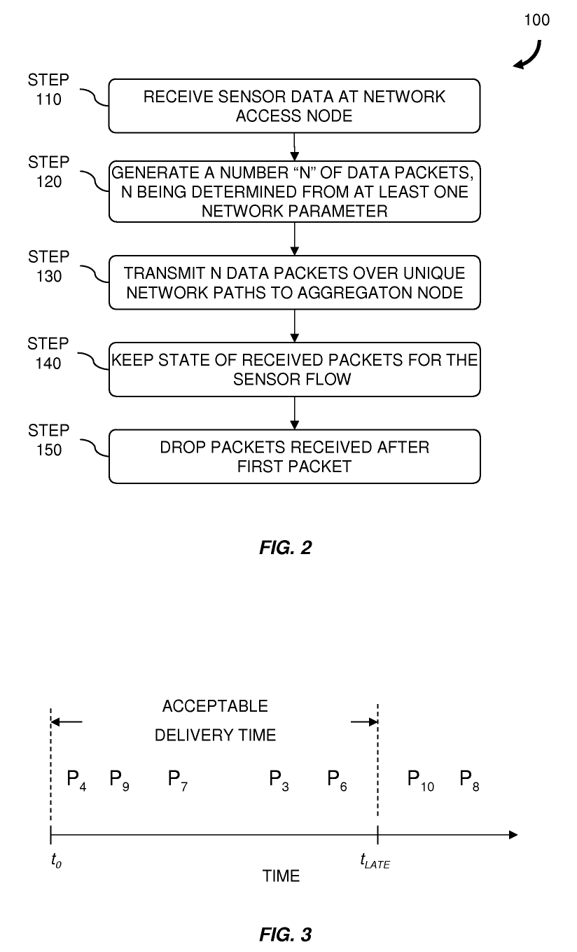

FIG. 2 is a flowchart representation of an embodiment of a method 100 for selectively multicasting sensor data for reliable transmission according to the invention. Referring to FIG. 1 and FIG. 2, sensor data from the sensor 26 is sent from the sensor gateway 30 and received (step 110) at the network access node 14 in a data packet P. The network access node generates (step 120) a number N of multicast data packets P₁ to P_{N} having identical sensor data and forwards (step 130) forwarded towards the aggregation node 18. The number N of multicast data packets is generally time-dependent and is based on one or more network parameters such as congestion, packet drop probability or rate and the number of available unique network paths. The network parameters can also be defined according to packet priority and class of service. If the bandwidth is limited, low priority data packets might not be duplicated while higher priority data packets are duplicated. The number N of data packets can change dynamically in a range from one to Nₘₐₓ where Nₘₐₓ is the maximum number of data packets supported according to customer requirements and the type and capacity of the network. The formula to determine the number N of multicast data packets can be different for different network access nodes 14.

Generally, using a greater number of network paths results in a greater likelihood of successful packet delivery. In one embodiment, routing tables are used to ensure that the data packets P are transmitted over different network paths. In contrast to forwarding tables, routing tables store all routes for all possible source nodes. In another embodiment, virtual private networks (VPNs), or tunnels, are established through separate network paths. Optionally, out-of-band VPN/tunnel and source routing tools can be used to achieve diverse paths. The invention also contemplates that multiple aggregation nodes 18 can receive the data packets such that all available unique paths between the network access node 14 and each aggregation node 18 are determined.

Sensor data flows can be identified according to the address for the sensor gateways 30. Each data packet P is given a unique identifier to ensure that all data packets P that arrive after the first data packet is received at the aggregation node 18 can be identified and dropped (i.e., deleted). In one embodiment, the unique identifier for packets in a particular sensor data flow is a timestamp which, in a further embodiment, is of the form (mm/dd/yy hh:mm:ss).

The state of the received data packets is maintained (step 140) at the aggregation node 18 for each sensor data flow that utilizes the method of the invention. All but the first data packet for a particular sensor data flow received at the aggregation node 18 and having a common timestamp are deleted (step 150). Thus applications do not have to manage sensor data packets with identical sensor data. This enables applications to scale with increasing numbers of sensors according to the method of the invention. Moreover, acknowledgements are not provided, so that state and buffering requirements at the network access node 14 are reduced. In an alternative embodiment, at least one later arriving data packet can be used in combination with a first-received data packet to implement error recovery.

FIG. 3 is a graphical representation of sensor data packets P arriving over time at an aggregation node. In this example, ten sensor data packets P₁ to P₁₀ are multicast from a network access node at a time t₀. Although all ten data packets P are sent simultaneously, the arrival time t for each data packet P is generally different due to transmit time and congestion for the different network paths. As shown, data packet P₄ is the first to arrive at the aggregation node and is forward to one or more applications authorized to receive the sensor data. Four additional data packets P₉, P₇, P₃ and P₆ are also received during an acceptable time interval (defined between t₀ and t_{LATE}), but they are dropped as they include redundant sensor data. Data packets P₁₀ and P₈ arrive late and are also deleted. Data packets P₁, P₂ and P₅ were dropped within the network and are never received at the aggregation node.

The method of the invention can be applied in a reverse manner. More specifically, an application node can send sensor commands to one or more sensors using command data packets having payloads that include the commands. Sensor commands can be used to activate or deactivate sensors, change the sensor sampling rate, change the sensor measurement resolution, initiate calibration and to control other sensor functions.

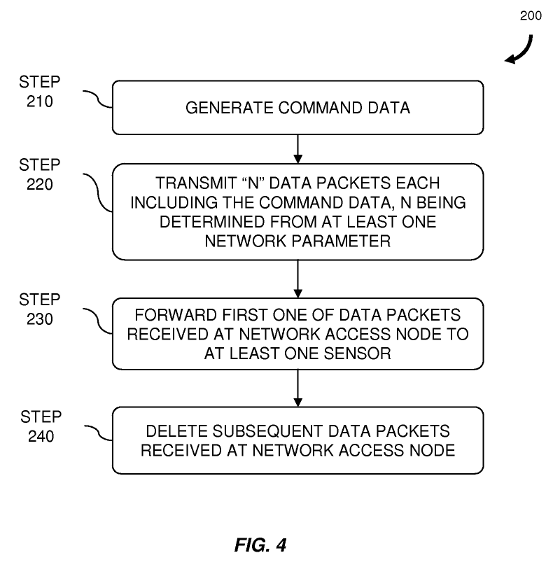

FIG. 4 is a flowchart representation of an embodiment of a method 200 to selectively multicast command data for reliable transmission to a sensor according to the invention. The command data are generated (step 210), for example, by an application desiring to control the sensor. Multiple command data packets having the same command data are multicast (step 220) from a network node, such as the aggregation node 18 in the network configuration 10 of FIG. 1. The number N of multicast command data packets is determined according to one or more network parameters in a similar manner to the method described above for sensor data packet transmission to application nodes. The first-received command data packet at another network node, such as the network access node 14, is forwarded (step 230) to one or more sensors to be controlled. All of the other multicast data packets having the same sensor data are deleted (step 240) upon receipt at the network node.

While the invention has been shown and described with reference to specific embodiments, it should be understood by those skilled in the art that various changes in form and detail may be made therein without departing from the spirit and scope of the invention.

What is claimed is:

1. A method for selectively multicasting sensor data for reliable transmission, the method comprising:
receiving sensor data at a network access node;
transmitting towards an aggregation node a number of data packets, each data packet having a payload comprising the sensor data, the number of data packets being determined in response to at least one network parameter;
forwarding a first one of the data packets received at the aggregation node to at least one application node; and
deleting any of the data packets received at the aggregation node after the first one of the data packets.

2. The method of claim 1 wherein the network parameter is time-dependent.

3. The method of claim 1 wherein the network parameter comprises a network congestion parameter.

4. The method of claim 1 wherein the network parameter comprises a packet drop probability.

5. The method of claim 1 wherein the network parameter comprises a packet priority.

6. The method of claim 1 wherein the network parameter comprises a desired class of service.

7. The method of claim 1 wherein the network parameter comprises a number of unique network paths available between the network access node and the aggregation node.

8. The method of claim 1 wherein the network access node is an edge node of a wireless network.

9. The method of claim 1 wherein each of the data packets has an identifier to indicate all data packets having the same sensor data.

10. The method of claim 9 wherein the deletion of any of the data packets received at the aggregation node is made in response to a determination that the respective identifiers are the same as the identifier of the first one of the data packets.

11. A method for selectively multicasting command data for reliable transmission to a sensor, the method comprising:
transmitting towards a network access node a number of data packets, each data packet having a payload comprising at least one sensor command, the number of data packets being determined in response to at least one network parameter;
forwarding a first one of the data packets received at the network access node to at least one sensor; and
deleting any of the data packets received at the network access node received after the first one of the data packets.

12. The method of claim 11 wherein the command data is responsive to sensor data received at the aggregation node.

13. A network for reliable transmission of sensor data comprising:
a network access node configured to receive sensor data from at least one sensor and to generate and transmit a number of data packets each having the sensor data and a common identifier; and
an aggregation node in communication with the network access node through a plurality of network paths, the aggregation node adapted to receive the transmitted data packets and to delete all but a first received one of the data packets.

14. The network of claim 13 wherein the number of data packets is determined in response to a time-dependent network parameter.

15. The network of claim 14 wherein the time-dependent network parameter comprises a network congestion parameter.

16. The network of claim 14 wherein the time-dependent network parameter comprises a packet drop probability.

17. The network of claim 14 wherein the time-dependent network parameter comprises a packet priority.

18. The network of claim 14 wherein the time-dependent network parameter comprises a desired class of service.

19. The network of claim 14 wherein the time-dependent network parameter comprises a number of unique network paths available between the network access node and the aggregation node.

20. A method for selectively multicasting sensor data for reliable transmission, the method comprising:
receiving sensor data at a network access node;
transmitting towards an aggregation node a number of data packets, each data packet having a payload comprising the sensor data, the number of data packets being determined in response to at least one network parameter;
generating an error-corrected data packet from a first one of the data packets and a later-received one of the data packets at the aggregation node; and
forwarding the error-corrected data packet to at least one application node.
